(19) United States
(12) Patent Application Publication
(10) Pub. No.: US 2026/0088992 A1
(43) Pub. Date: Mar. 26, 2026

(54) METHODS, ARCHITECTURES, APPARATUSES AND SYSTEMS FOR RELAY COMMUNICATION SECURITY USING BOOTSTRAPPING

(71) Applicant: InterDigital Patent Holdings, Inc., Wilmington, DE (US)

(72) Inventors: Samir Ferdi, Kirkland (CA); Jung Je Son, Warrington, PA (US); Taimoor Abbas, Sainte-Julie (CA)

(21) Appl. No.: 18/897,266

(22) Filed: Sep. 26, 2024

(51) Int. Cl. H04L 9/08

(52) U.S. Cl. CPC H04L 9/088

(57) ABSTRACT

A method, implemented in a WTRU is described herein. The method may include (i) sending a registration request to a network, indicating a capability to use relay security with bootstrap keys (RSBK), (ii) receiving a registration accept from the network, indicating an authorization for the WTRU to use RSBK, (iii) generating an anchor key and an anchor key identifier during a primary authentication procedure, (iv) deriving a remote user key from at least the anchor key based on the authorization to use RSBK, (v) sending a connection request to a relay, including at least the anchor key identifier and a first nonce, (vi) receiving a security establishment request from the relay, including a second nonce, and (vii) deriving a root key to be shared between the WTRU and the relay based on at least the remote user key, the first nonce and the second nonce.

### TECHNICAL FIELD

The present disclosure is generally directed to the fields of communications, software and encoding, including methods, architectures, apparatuses, and systems directed to relay communication security using bootstrapping.

### BACKGROUND

Third generation partnership project (3GPP) has defined procedures for communication including security and privacy since Release 17. Relay communication security procedures include user plane (UP) and control plane (CP) procedures which may lead to different deployment scenarios with incompatibilities across various networks. Embodiments described herein have been designed with the foregoing in mind.

### SUMMARY

Methods, architectures, apparatuses, and systems directed to relay communication security using bootstrapping are described herein. In an embodiment, a wireless transmit/receive unit (WTRU) is described. The WTRU may include circuitry including any of transmitter, a receiver, a processor, and a memory. The WTRU may be configured to send a registration request to a network. In various embodiments, the registration request may indicate a capability to use relay security with bootstrap keys (RSBK). The WTRU may be configured to receive a registration accept from the network. In various embodiments, the registration accept may indicate an authorization for the WTRU to use RSBK. The WTRU may be configured to generate an anchor key and an anchor key identifier during a primary authentication procedure. The WTRU may be configured to derive a remote user key from at least the anchor key based on the authorization to use RSBK. The WTRU may be configured to send a connection request to a relay. In various embodiments, the connection request may comprise at least the anchor key identifier and a first nonce. The WTRU may be configured to receive a security establishment request from the relay. In various embodiments, the security establishment request may comprise a second nonce. The WTRU may be configured to derive a root key to be shared between the WTRU and the relay based on at least the remote user key, the first nonce and the second nonce.

In an embodiment, a method implemented in a WTRU is described. The method may include sending a registration request to a network. In various embodiments, the registration request may indicate a capability to use relay security with bootstrap keys (RSBK). The method may include receiving a registration accept from the network. In various embodiments, the registration accept may indicate an authorization for the WTRU to use RSBK. The method may include generating an anchor key and an anchor key identifier during a primary authentication procedure. The method may include deriving a remote user key from at least the anchor key based on the authorization to use RSBK. The method may include sending a connection request to a relay. In various embodiments, the connection request may comprise at least the anchor key identifier and a first nonce. The method may include receiving a security establishment request from the relay. In various embodiments, the security establishment request may comprise a second nonce. The method may include deriving a root key to be shared between the WTRU and the relay based on at least the remote user key, the first nonce and the second nonce.

In an embodiment, a first network element is described. The first network element may include circuitry including any of transmitter, a receiver, a processor, and a memory. The first network element may be configured to receive a key request from a second network element associated with a relay. In various embodiments, the key request may indicate an anchor key identifier, a first nonce and a relay service code. The first network element may be configured to send a user key request to an anchor function of a WTRU. In various embodiments, the user key request may indicate the anchor key identifier and the relay service code. The first network element may be configured to receive a user key response from the anchor function of the WTRU. In various embodiments, the user key response may indicate a remote user key and an identifier of the WTRU. The first network element may be configured to derive a root key to be shared between the WTRU and the relay based on at least the remote user key, the first nonce and a second nonce. The first network element may be configured to send a key response to the second network element associated with the relay. In various embodiments, the key response may indicate the root key and the second nonce.

In an embodiment, a method implemented in a first network element is described. The method may include receiving a key request from a second network element associated with a relay. In various embodiments, the key request may indicate an anchor key identifier, a first nonce and a relay service code. The method may include sending a user key request to an anchor function of a WTRU. In various embodiments, the user key request may indicate the anchor key identifier and the relay service code. The method may include receiving a user key response from the anchor function of the WTRU. In various embodiments, the user key response may indicate a remote user key and an identifier of the WTRU. The method may include deriving a root key to be shared between the WTRU and the relay based on at least the remote user key, the first nonce and a second nonce. The method may include sending a key response to the second network element associated with the relay. In various embodiments, the key response may indicate the root key and the second nonce.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example key hierarchy for user plane-based security;

FIG. 3 is a diagram illustrating an example procedure for authentication and key management for applications (AKMA) key generation;

FIG. 4 is a diagram illustrating an example procedure for application function key (KAF) generation;

FIG. 5 is a diagram illustrating an example AKMA key hierarchy;

FIG. 6 is a diagram illustrating a security establishment procedure for relay communication between a WTRU and a relay;

FIG. 7 is a diagram illustrating an example key hierarchy for relay communication security using RSBK;

FIG. 8 is a diagram illustrating an example method for relay communication security using bootstrapping, implemented in a WTRU; and

FIG. 9 is a diagram illustrating an example method for relay communication security using bootstrapping, implemented in a network element.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

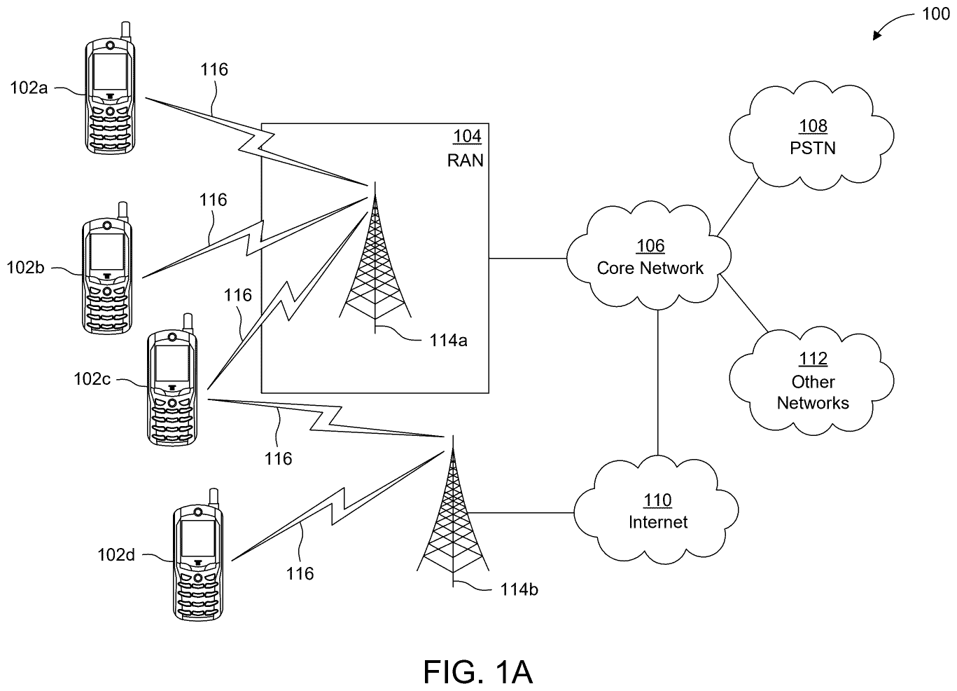

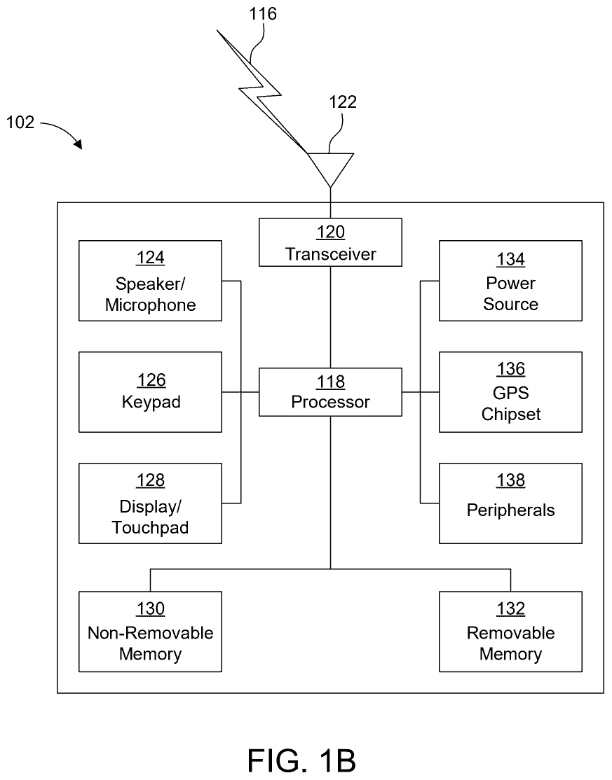

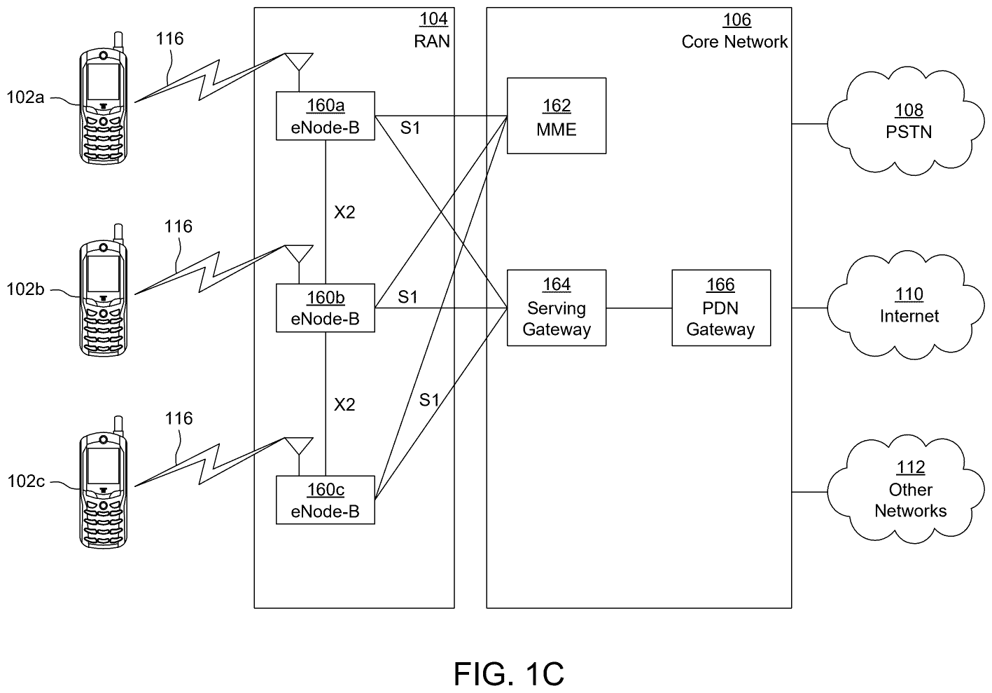

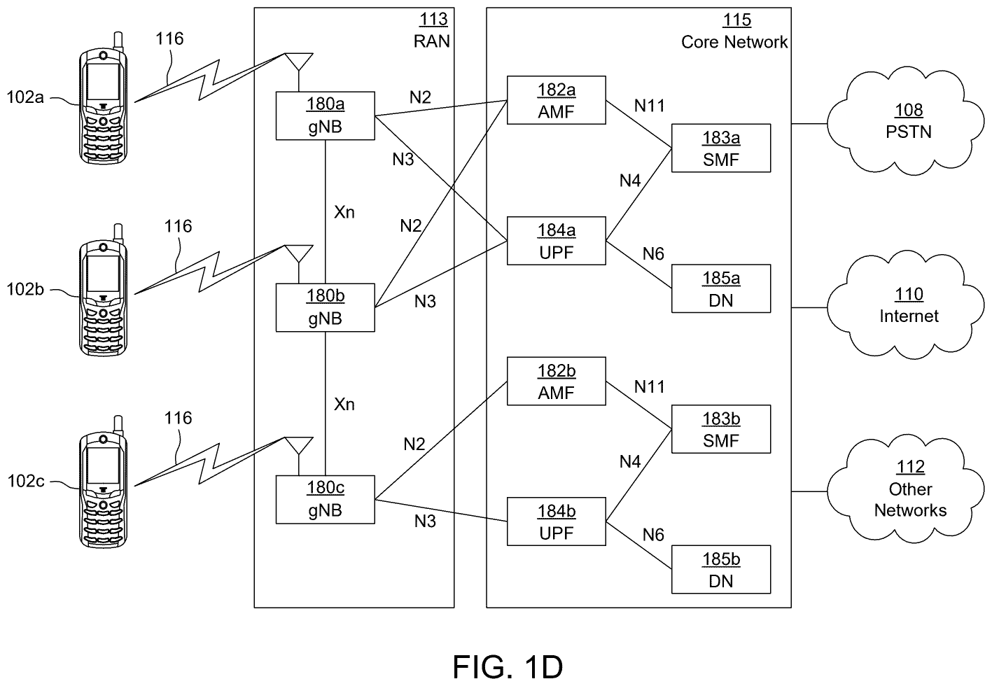

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

In embodiments described herein, the terms “relay” and “relay WTRU” may be used interchangeably.

In embodiments described herein, the terms “end WTRU”, “remote WTRU”, collectively “WTRU” may be used interchangeably to refer to any WTRU communicating with a relay.

### Overview of Relay Communication Security Using Bootstrapped Keys in a WTRU

In an example, a WTRU may establish the security for the connection with a relay using keys bootstrapped with assistance of a proximity-based service (Prose) key management function (PKMF) of the WTRU. The PKMF of a remote WTRU may provide bootstrapped key to a relay (via the PKMF of the relay) to establish the security for the connection with the remote WTRU.

In an example, a remote (e.g., end) WTRU may behave as follows.

The WTRU may register with the network e.g., based on providing an indication of relay security with bootstrapped keys (RSBK) capability.

The WTRU may generate an anchor key (such as e.g., an authentication and key management for applications (AKMA) anchor key (KAKMA) and an anchor key identifier (A-KID) during the primary authentication procedure.

The WTRU may receive provisioning information from the network including a relay service code (RSC) with an RSBK indication.

The WTRU may discover a relay that may support the RSC with an RSBK indication.

The WTRU may derive a remote user key (such as e.g., a Prose remote user key (PRUK)) using, for example, KAKMA and RSC. In another example, RSC may be used in key NR Prose (KNRP) derivation and may not be used in PRUK derivation.

The WTRU may send a connection request (such as e.g., a direct connection request (DCR) to the relay including any of the A-KID, a first nonce (e.g., referred to herein as nonce1) and the RSC.

The WTRU may receive a security establishment request (such as e.g., a direct security mode (DSM) command message from the relay including a second nonce (e.g., referred to herein as nonce2).

The WTRU may derive a root key to be shared between the WTRU and the relay (such as e.g., a KNRP) using PRUK, nonce1 and nonce2. The WTRU may derive a session key and security keys using KNRP.

The WTRU may verify the security establishment request (e.g., DSM command message) security using the security keys.

The WTRU may send a security establishment response (such as e.g., a DSM complete message) protected using the security keys.

The WTRU may receive a connection accept (such as e.g., a direct connection accept (DCA) message) from the relay completing the connection establishment.

Embodiments are described herein with an AKMA anchor key (KAKMA) and a KAKMA key identifier as examples of anchor key and anchor key identifier. Embodiments described herein are not limited to a KAKMA and a KAKMA ID and are applicable to any kind of anchor key and anchor key identifier. In embodiments described herein, the terms “AKMA key”, “AKMA anchor key”, “K_{AKMA}”, collectively “KAKMA” may be used interchangeably.

In embodiments described herein, an RSC with an RSBK indication may refer to an RSC associated with an indication to use RSBK, e.g., during a relay connection establishment procedure. In embodiments described herein, RSBK indication and RSBK indicator may be used interchangeably.

Embodiments are described herein with a PRUK as an example of remote user key. Embodiments described herein are not limited to a PRUK and are applicable to any kind of remote user key.

Embodiments are described herein with a DCR message as an example of a connection request. Embodiments described herein are not limited to a DCR and are applicable to any kind of connection request.

Embodiments are described herein with a DSM command message and a DSM complete message as examples of a security establishment request and a security establishment response. Embodiments described herein are not limited to a DSM command/complete message and are applicable to any kind of security establishment request/response.

Embodiments are described herein with a KNRP as an example of root key to be shared between a WTRU and a relay. Embodiments described herein are not limited to a KNRP and are applicable to any kind of root key to be shared between a WTRU and a relay.

Embodiments are described herein with a DCA message as an example of a connection accept message. Embodiments described herein are not limited to a DCA message and are applicable to any kind of connection accept messages for completing a connection establishment procedure.

### Overview of Relay Communication Security Using Bootstrapped Keys in a Network Element

In an example, a first network element (such as e.g., a PKMF of a remote WTRU) may behave as follows.

The first network element may receive a key request from a second network element associated with a relay (such as e.g., a PKMF of the relay) including any of an A-KID, a first nonce (e.g., referred to herein as nonce1), and RSC.

The first network element may check (e.g., determine) whether a valid remote user key (such as e.g., a PRUK) may be stored for the A-KID and RSC.

The first network element may send a user key request (such as e.g., a AKMA ProSe user key request) to an anchor function of a WTRU (such as e.g., an AKMA anchor function (AAnF) of the WTRU), e.g., based on no valid remote user key being stored for the A-KID and RSC. The user key request may be sent to the anchor function of the WTRU directly or via a network exposure function (NEF), The user key request may include the A-KID and the RSC. For example, the AAnF may derive a remote user key (such as e.g., a PRUK) using KAKMA and RSC.

The first network element may receive a user key response (such as e.g., an AKMA ProSe user key response from the anchor function (e.g., AAnF) of the WTRU including the remote user key (such as e.g., the PRUK), and an identifier of the WTRU (WTRU ID), such as e.g., any of a subscription permanent identifier (SUPI) and a general public subscription identifier (GPSI).

The first network element may store the remote user key (such as e.g., the PRUK) along with the A-KID and WTRU ID.

The first network element may derive a root key to be shared between the WTRU and the relay (such as e.g., a KNRP) using the remote user key (e.g., PRUK), the first nonce (e.g., nonce1) and a second nonce (e.g., nonce2).

The first network element may send a key response to the second network element associated with the relay (such as e.g., the PKMF of the relay) including the root key (e.g., KNRP) and the second nonce (e.g., nonce2).

Embodiments are described herein with a PKMF/PAnF of a WTRU and a PKMF/PAnF of a relay as examples of a first and a second network elements respectively associated with the WTRU and the relay. Embodiments described herein are not limited to a PKMF/PAnF of a WTRU/relay and are applicable to any kind of network elements capable of hosting a network function associated with the WTRU/relay.

Embodiments are described herein with a AKMA ProSe user key request/response as examples of user key request/response. Embodiments described herein are not limited to AKMA ProSe user key request/response and are applicable to any kind of user key request/response messages/commands.

Embodiments are described herein with an AAnF of a WTRU as an example of an anchor function of the WTRU. Embodiments described herein are not limited to an AAnF of a WTRU and are applicable to any kind of network elements capable of hosting an anchor function associated with the WTRU.

### Relay Communication Security

3GPP has defined procedures for relay (WTRU to network (U2N) and WTRU to WTRU (U2U)) communication including security and privacy since Release 17, as described, for example in 3GPP technical specification (TS) 23.503 v18.3.0 and 3GPP TS 23.304 v19.0.0.

U2N relay communication security supports two alternative procedures using user plane (UP) and control plane (CP) based security mechanisms where a root credential, referred to herein as ProSe remote user key (PRUK) may be respectively provisioned and generated.

In CP based security, a remote WTRU may establish the root credential (CP-PRUK) with a remote WTRU home public land mobile network (HPLMN) (authentication server function (AUSF)/user data management (UDM)/Prose anchor function (PAnF)) during a ProSe authentication procedure as part of PC5 link establishment with the U2N relay. In this authentication, the 3GPP credential may be stored in the remote WTRU universal integrated circuit card (UICC).

In UP based security, the remote WTRU may be configured by its PKMF with the root credential (UP-PRUK). UP-PRUK may (e.g., also) be generated as part of PC5 link establishment with the U2N relay using a general bootstrapping architecture (GBA) push mechanism which may (e.g., also) rely on the 3GPP credential being stored in the remote WTRU UICC. PKMF may use AKMA or GBA to secure communication with the remote WTRU (over PC8 interface).

U2U relay communication security with network assistance reuse procedures defined for U2N relay.

The PRUK may be used to establish a PC5 link root key KNRP shared between the remote WTRU and U2N relay and used to derive any of session and security keys. The remote WTRU may derive a KNRP from a PRUK and the U2N relay may receive a KNRP from the network (e.g., PKMF or AMF).

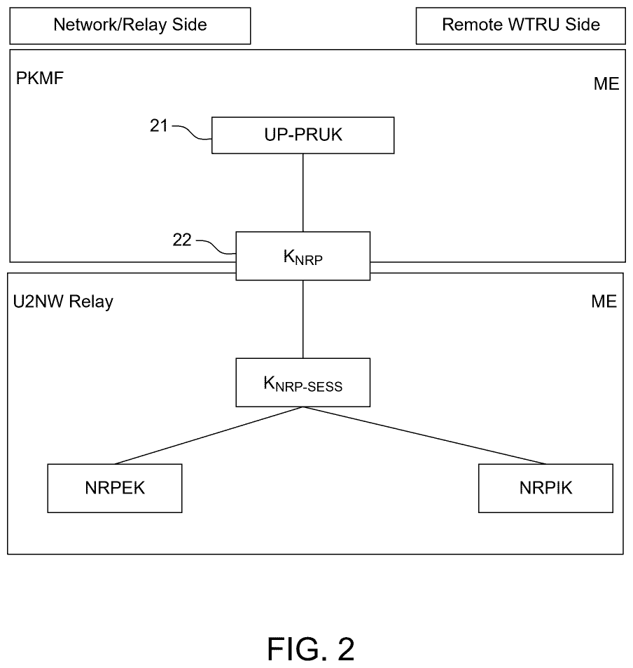

FIG. 2 is a diagram illustrating an example key hierarchy for user plane-based security. The PKMF and remote WTRU may derive from UP-PRUK 21 a KNRP 22 to be used as the root key for the PC5 link between the remote WTRU and the U2N relay. The PKMF may provide the KNRP 22 to the U2N relay via user plane during a key request procedure. The remote WTRU may derive the KNRP during the direct security establishment procedure, e.g., using direct security mode command (DSMC) over the PC5 link with the U2N relay. The remote WTRU and the relay may further derive the session key and security keys from KNRP during DSMC procedure. A similar key hierarchy may be defined for the CP approach. The main difference is that the root credential (CP-PRUK) may be derived by AUSF and the remote WTRU during a ProSe authentication procedure via the U2N relay/NAS messaging.

### Authentication and Key Management for Applications

Authentication and key management for applications (AKMA) is described herein.

Security features and mechanisms to support authentication and key management aspects for applications based on subscription credential(s) in 5G system (AKMA) are specified in 3GPP TS 33.535 v18.4.0.

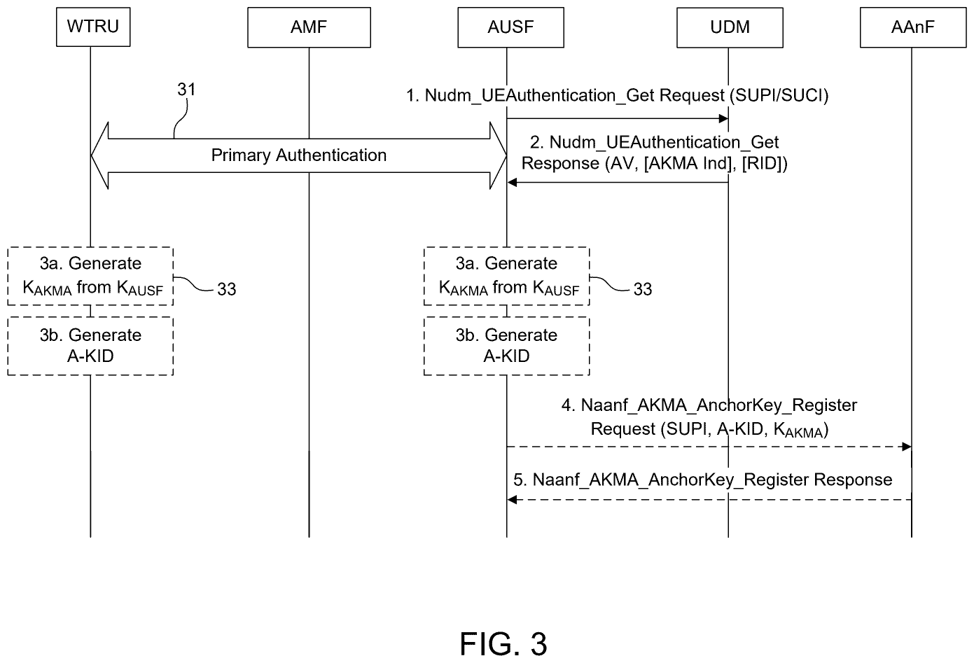

FIG. 3 is a diagram illustrating an example procedure for AKMA key (KAKMA) generation. As shown at 33, an AKMA key (KAKMA) may be derived by the network (AUSF) and the WTRU from an access key (KAUSF) following a primary authentication procedure 31. A single KAKMA key, identified by a AKMA key identifier (A-KID), may be established per WTRU. The A-KID may be in a network access identifier (NAI) format, e.g., username@realm. The username part may include a routing indicator (RID) and the AKMA temporary WTRU identifier (A-TID). The realm part may include the home network identifier. The A-TID may be derived from the SUPI using KAUSF to preserve SUPI privacy.

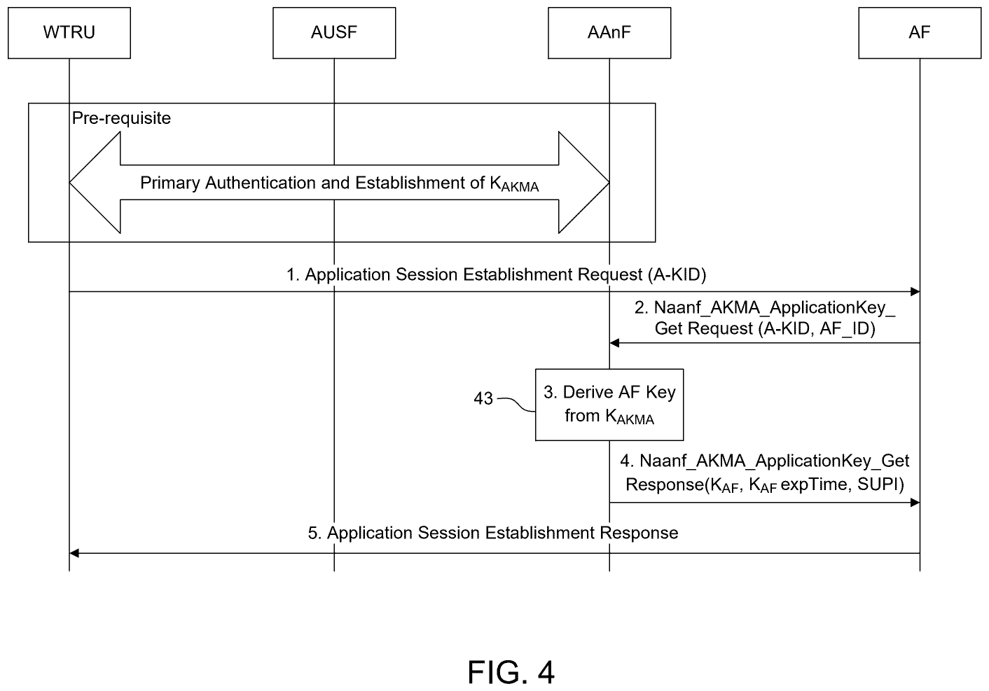

FIG. 4 is a diagram illustrating an example procedure for application function key (KAF) generation. As shown at 43, an AF key (KAF) may be derived from KAKMA by the WTRU and the network (AKMA anchor function (AAnF)) and provided by the network to the application function (AF), to be used for secure application layer communication (including mutual authentication) between the WTRU and the AF. A single KAF may be derived per application, by binding KAF to the AF fully qualified domain name (FQDN) (AF_ID) used as input into the key the derivation function.

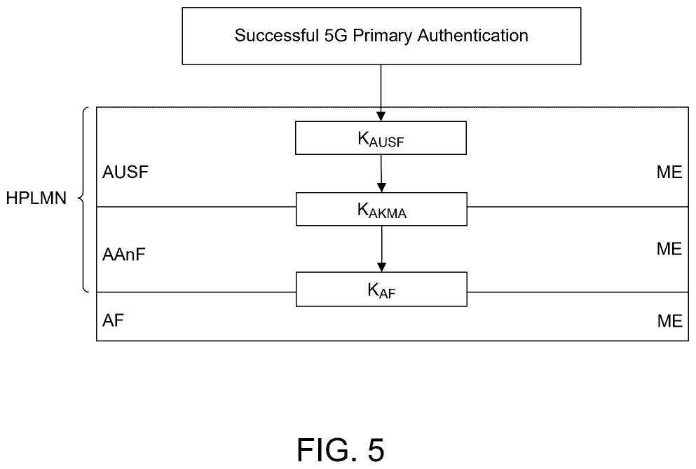

FIG. 5 is a diagram illustrating an example AKMA key hierarchy.

The application specific interface between the WTRU and the AF (referred to as Ua*) may use different authentication protocols for which different normative “AKMA profiles” are specified in 3GPP TS 33.535 v18.4.0, Annex B).

The existing relay communication security procedures (CP and UP) present some pros and cons as summarized herein.

UP based procedure assumes that the remote WTRU may obtain an UP-PRUK primarily while in coverage and prior to connecting to the relay. In another example, the UP-PRUK may be generated by the remote WTRU and its PKMF may use a GBA push mechanism during the connection with the U2N relay. Such mechanism may (e.g., only) be supported if GBA is used by the PKMF (which may use AKMA instead). This may (e.g., also) be based on the PKMF being authorized to de-conceal the subscription concealed identifier (SUCI) sent by the remote WTRU, into a SUPI, which may not (e.g., always) be allowed based on operator privacy considerations. The UP based procedure may support any roaming scenario given that the relay can communicate directly with the relay's PKMF, which in turn may communicate with the PKMF of the remote WTRU.

CP based procedure may allow the remote WTRU to connect to the relay regardless (e.g., independently) of its coverage state. In an example, the serving network AMF may not support the ProSe authentication procedure, as the remote WTRU may be roaming. CP base procedure supports natively existing 3GPP credentials by reusing a primary authentication-like procedure, which may simplify key management for the operator by enabling the WTRU to reuse network access credentials for relay access authorization.

Given the differences and incompatibility between UP based and CP based approaches, operators may decide to deploy (e.g., only) one for the support of the U2N relay feature (e.g., for cost effectiveness and/or simplification of deployment reasons). The deployment of incompatible U2N relay security procedures across various networks may lead to some level of market fragmentation and prevent a wider and seamless support of U2N relay (e.g., in roaming scenarios).

Embodiments described herein enable a unified approach for U2N relay communication security by addressing the respective limitations of the existing procedures and allow simplifying implementation options for network operators.

In embodiments described herein, a WTRU may use network assistance over user plane to establish a key (PRUK) that may be the root of the security of the link between the WTRU and the relay. In an example, the PRUK may be bootstrapped based on 3GPP credentials. The bootstrapping mechanism, which may be referred to as relay security with bootstrapped keys (RSBK), may leverage and enhance AKMA procedures to derive the PRUK from the KAKMA key established during the WTRU primary authentication.

Embodiments described herein may support roaming scenarios for the WTRU and relay as the procedure may use communication over user plane with the network (e.g., PKMF in the relay/WTRU HPLMN). The credentials for relay communication security may be generated (e.g., cryptographically bound) based on the 3GPP credentials used for primary authentication. The mechanism may enable simplified credentials management for the operator (e.g., avoiding separate/independent PRUK maintenance in PKMF) and robust relay communication security that may be based on the strong security provided by using keys generated from the primary authentication.

### Relay Communication Security Using Bootstrapped Keys

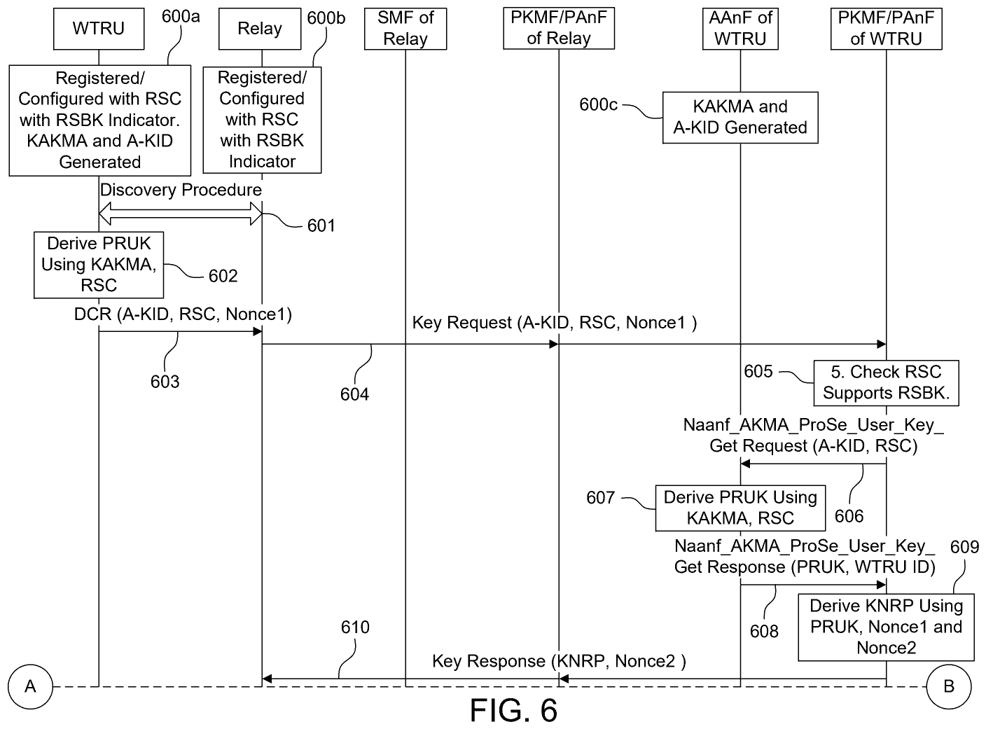

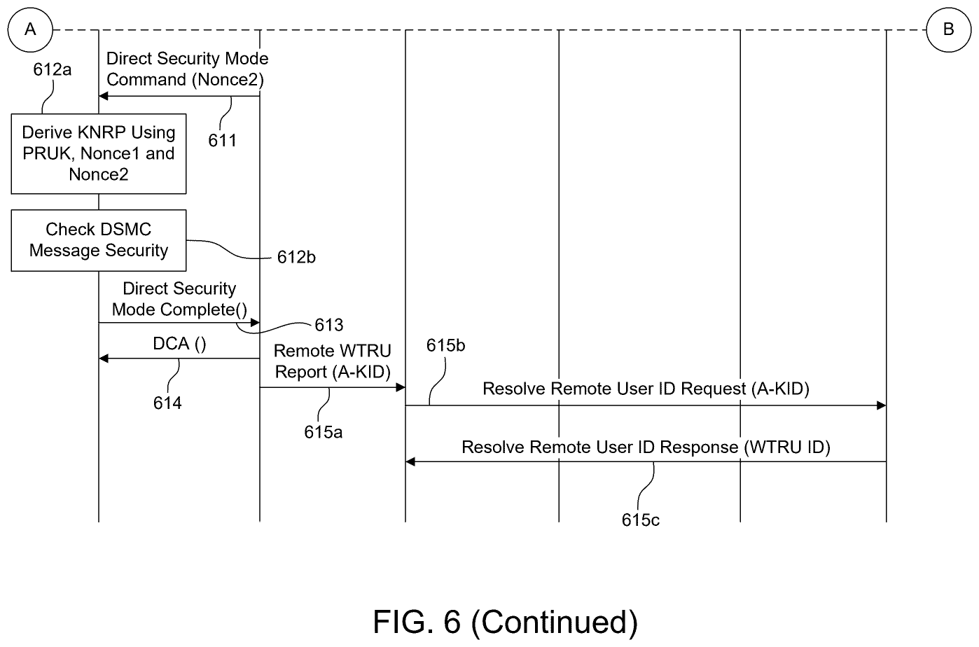

FIG. 6 is a diagram illustrating a security establishment procedure for relay communication between a WTRU (e.g., remote or end WTRU) and a relay (e.g., U2N or U2U relay) using a relay security with bootstrapped keys (RSBK) mechanism. The WTRU may establish the security for the connection with a relay using keys bootstrapped with assistance of the PKMF of the WTRU. The PKMF of the WTRU may send a bootstrapped key to the relay (via the PKMF of the relay) over user plane. The bootstrapped key may be used by the relay to establish the security for the connection with the WTRU. An example of key hierarchy using RSBK is described herein later.

As shown at 600a, 600b and 600c, the WTRU and the relay may be registered in the network and configured by the network with an RSC with an RSBK indicator. The WTRU may send an indication of RSBK capability (e.g., included in a registration request message) to the network, e.g., during registration. The WTRU may receive an acceptance message from the network (e.g., in a registration accept) indicating an authorization for the WTRU to use RSBK during relay connection procedure. For example, the WTRU may be AKMA capable and may have established a KAKMA and A-KID with the network (AAnF) during primary authentication procedure (as described herein). The PKMF/PAnF may be pre-configured with the RSCs which may support RSBK.

As shown as 601, the WTRU may perform a discovery procedure. The WTRU may discover a relay that may support the RSC with a RSBK indication.

As shown as 602, based on above network acceptance for using RSBK and/or RSC being associated with an RSBK indication, the WTRU may derive a PRUK using the KAKMA and RSC. Examples of PRUK derivations are described herein later. When (e.g., every time) the WTRU runs through a primary authentication a new (e.g., different) KAKMA may be generated and used for subsequent PRUK generation used for relay connection.

As shown as 603, the WTRU may send a DCR message to the relay including any of an A-KID, RSC and nonce1.

As shown as 604, the relay may send a key request message to the PKMF of the WTRU via the PKMF of the relay. The relay may include any of an A-KID, RSC and nonce1 in the key request message. The PKMF of the relay may route/forward the request to the PKMF of the WTRU based on routing information included in the A-KID.

As shown as 605, the PKMF of the WTRU may check whether a valid PRUK may already be stored by locating the PRUK using the (e.g., given) A-KID and RSC. The PRUK may have been established during a prior connection via the same or a different relay, or prior to connection to a relay as described herein. In that case, the PKMF may skip operations shown at 606-608 to perform the operation shown at 609. The PKMF of the WTRU may verify that the RSC may support RSBK before performing the next operation. If RSC does not support RSBK, the PKMF of the WTRU may check whether the WTRU is allowed to connect using a legacy RSC (e.g., that may support CP or UP based security mechanisms, based on PKMF local configuration and/or WTRU subscription data from UDM). If the WTRU is not allowed the PKMF of the WTRU may reject the requests from the PKMF of the relay which may inform the relay. In that case, the relay may reject the connection requests of the WTRU (e.g., with a cause code indicating that WTRU may not be authorized to connect to the relay using the (CP or UP enabled) RSC).

As shown as 606, the PKMF of the WTRU may send to the AAnF of the WTRU a user key request (such as e.g., an AKMA ProSe user key request) message (directly or via NEF) that may include any of the A-KID and the RSC.

As shown as 607, the AAnF of the WTRU may check (e.g., determine) that the WTRU may be authorized to use RSBK based on WTRU subscription data and/or AAnF local configuration. If the WTRU is authorized, the AAnF of the WTRU may derive the PRUK the same way as the WTRU as shown at 602 (e.g., using KAKMA, RSC). If the WTRU is not authorized, the AAnF may reject the request from the PKMF of the WTRU which may inform the relay via the PKMF of the relay. In that case, the relay may reject the connection requests of the WTRU (e.g., with a cause code indicating that WTRU may not be authorized to connect to the relay using the (e.g., given) RSC).

As shown as 608, the AAnF of the WTRU may send to the PKMF of the WTRU a user key response (such as e.g., an AKMA ProSe user key response) message including the PRUK, and a WTRU ID (such as e.g., any of SUPI, GPSI).

As shown as 609, the PKMF of the WTRU may store locally the PRUK e.g., along with A-KID and WTRU ID. The PKMF of the WTRU may derive a KNRP using the PRUK, the nonce1 and a nonce2. Examples of KNRP derivations are described herein later.

As shown as 610, the PKMF of the WTRU may send to the relay via the PKMF of the relay a key response message including KNRP, nonce2.

As shown as 611, the relay may use conventional methods to derive a session and security keys (integrity, confidentiality) using KNRP. The relay may send to the WTRU an integrity protected DSM command message including nonce2.

As shown as 612a, the WTRU may derive a KNRP the same way the PKMF of the WTRU as shown at 609. The WTRU may derive a session key and security keys using KNRP the same way as the relay as shown at 611. As shown as 612b, the WTRU may verify the DSM command message security protection.

As shown as 613, the WTRU may send a protected DSM complete message to complete the security establishment.

As shown as 614, the relay may verify the DSM complete message security protection. The relay may send to the WTRU a DCA message completing the relay connection establishment.

As shown as 615a, the relay may send to the serving SMF a remote WTRU report message that may include the A-KID received as shown at 603. The SMF may locate the PKMF of the WTRU based on routing information included in the A-KID. As shown at 615b, the SMF may send to the PKMF of the WTRU a resolve remote user ID request message including the A-KID. As shown at 615c the SMF may receive a response from the PKMF of the WTRU that may include the WTRU ID of the WTRU, which the SMF may store in the relay session management context.

In another example, the WTRU may establish a PRUK with the PKMF of the WTRU prior to connecting with a relay. The WTRU may send to the PKMF of the WTRU a (e.g., PRUK) request message including (e.g., indicating) the A-KID and zero or more RSC the WTRU may (e.g., wish to) use. The PKMF may request a PRUK from AAnF as described here above and may store the PRUK along A-KID. The PKMF may send an acknowledgement response message to the WTRU. Based on a positive response, the WTRU may derive the PRUK as described here above. If the PRUK is bound to (e.g., derived using) a particular RSC, the WTRU may send the RSC along A-KID to the PKMF, where the RSC may be used in the derivation of PRUK. In such a case, the WTRU may send separate requests to establish a PRUK for (e.g., each of) the different RSC (e.g., including a different RSC) or a single request including multiple RSCs.

The WTRU and PKMF of the WTRU may establish a PRUK (e.g., automatically) when the WTRU may establish an application session with the PKMF. In such a case the PKMF may obtain a KAF key from AAnF as per AKMA procedure e.g., as shown at FIG. 4, for the security of the communication with the WTRU (PC8 interface). In addition, the PKMF may request and may receive a PRUK used for relay communication security. The successful application session establishment may indicate a successful PRUK establishment at the PKMF to the WTRU, which may derive a PRUK used for connecting with a relay.

In an example, with PRUK pre-established (e.g., via a prior relay connection as shown at FIG. 6 or as described herein), the WTRU may connect with the relay using the procedure described above (with PKMF skipping the interactions with AAnF as described above). The WTRU may perform such PRUK pre-establishment when in coverage and/or with access to a data connection prior to connecting with a relay.

### Example Key Hierarchy for Security With Bootstrapped Keys

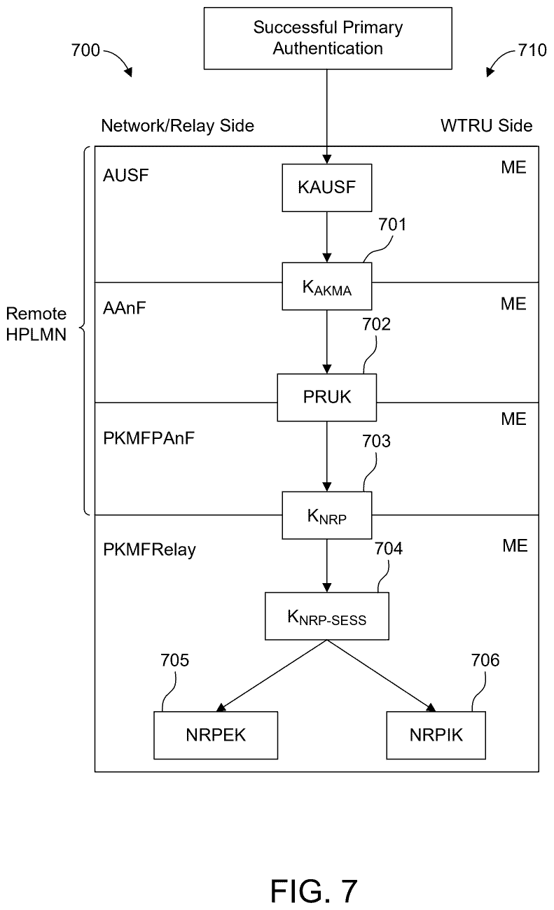

FIG. 7 is a diagram illustrating an example key hierarchy for relay communication security using RSBK based on a AKMA key hierarchy. The relay (left) side, shown at 700 corresponds to a U2N or U2U relay. The WTRU (right) side shown at 710 corresponds to a (e.g., remote, end) WTRU (e.g., connecting with a U2N or U2U relay, respectively).

In an example, the WTRU and the AAnF may derive (e.g., determine) a PRUK 702 using AKMA key 701 which may be derived as previously described.

The PKMF/PAnF may obtain the PRUK 702 from the AAnF upon (e.g., based on) direct request from the WTRU (e.g., while in coverage, prior to connection with relay) or during WTRU connection with the relay, upon (e.g. based on) request from a relay via the relay's PKMF as previously described.

The WTRU and PKMF/PAnF may derive (e.g., determine) the KNRP 703 using PRUK 702, for example, while the relay may receive the KNRP 703 from the PKMF of the WTRU via the PKMF of the relay. The WTRU and the relay may derive (e.g., determine) the session and security keys using KNRP 703.

Examples of key derivation function (KDF) that may be used to derive (e.g., determine) a PRUK from a KAKMA are described herein.

In a first example, the PRUK may be determined as a function of the KAKMA and the RSC (e.g., PRUK=KDF (KAKMA, RSC)). In this example, the PRUK may be bound to a particular RSC and a different PRUK may (e.g., need to) be derived by the WTRU and the network for a (e.g., each) connection using a different RSC. The WTRU may reuse that PRUK when connecting to different relays providing the same RSC.

In a second example, the PRUK may be determined as a function of the KAKMA and a string (e.g., PRUK=KDF (KAKMA, string)). The string parameter may, for example, be equal to “PRUK” or “ProSe”. In this example, the PRUK may not be bound to a particular RSC and the WTRU may reuse the same PRUK for different relay connections that may use different RSCs. In that example, the KNRP may be bound to the RSC as described here below.

Examples of KDF that may be used to derive a KNRP from a PRUK are described herein.

In a first example, a KNRP may be determined as a function of a PRUK, a first nonce and a second nonce (e.g., KNRP=KDF (PRUK, nonce1, nonce2) where nonce1 and nonce2 parameters may be exchanged between the WTRU, the PKMF and the relay during the relay connection establishment as previously described.

In a second example, a KNRP may be determined as a function of a PRUK, an RSC, a first nonce and a second nonce (e.g., KNRP=KDF (PRUK, RSC, nonce1, nonce2)). If the PRUK is not bound to a particular RSC as described here above, the KNRP derivation may include RSC as input parameter to the KDF such that (e.g., to ensure) a fresh/unique KNRP may be used across different relay connections using different RSCs (e.g., to avoid attacks exploiting same KNRP potentially being reused).

Any of the session key (KNRP-Session) 704, encryption key (NRPEK) 705 and integrity key (NRPIK) 706 may be derived (e.g., determined) using KNRP 703, for example, according to conventional methods.

### Backward Compatibility Considerations

Backward compatibility with legacy WTRUs and relay supporting existing relay communication security CP-based or UP-based procedures are described herein.

A network function (NF), such as e.g., a new PKMF (NPKMF) combining legacy PAnF and PKMF functionality (respectively for CP and UP based procedures) and enhanced with RSBK functionality described herein may be used. The NPKMF may support legacy interface with AUSF for PRUK generation based on CP mechanism. The NPKMF may support legacy PKMF behavior for PRUK generation (e.g., local key generation, using GBA push) based on UP mechanism.

Legacy WTRU/relays without RSBK capability are not provisioned with RSC with RSBK indication. Legacy WTRU/relays (e.g., without RSBK capability) may be provisioned with RSC with CP or UP indicator, depending on the HPLMN preference. For example, the corresponding legacy functionality in the NPKMF (PAnF or PKMF) may be invoked during the relay connection establishment.

New RSBK capable WTRUs, described herein may use NPKMF assistance for RSBK based mechanism as described here above for RSC with RSBK indicator. New RSBK capable WTRUs may use legacy RSC (with CP or UP indicator) as well. This may be useful to allow the (e.g., new) RSBK capable WTRUs to be able to connect with a relay providing (e.g., only) legacy RSC (and no RSBK RSC). For example, the (e.g., new) RSBK capable WTRU may establish a PRUK and PRUK ID with the NPKMF of the WTRU using RSBK based mechanism prior to connecting with the relay (as described here above). The (e.g., new) RSBK capable WTRU may send PRUK ID to the relay and perform the legacy security procedure, depending on the RSC indicator (CP or UP). In that case the NPKMF may play the role of the legacy PAnF or PKMF respectively, transparently to the serving network, relay and PKMF of the relay.

### Example Methods for Relay Communication Security Using Bootstrapping

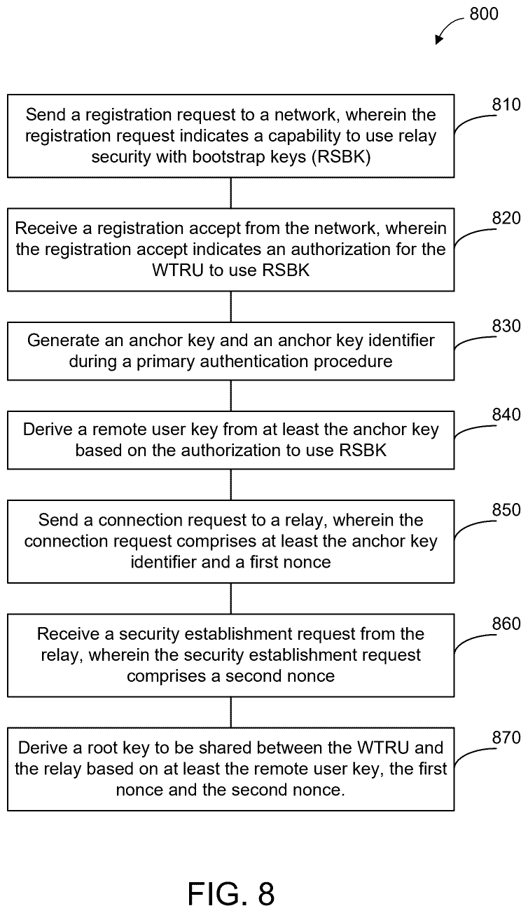

FIG. 8 is a diagram illustrating an example method 800 for relay communication security using bootstrapping, implemented in a WTRU. The WTRU may include circuitry including any of transmitter, a receiver, a processor, and a memory. The circuitry may be configured to carry out the method 800. As shown at 810, the method 800 may include sending a registration request to a network. In various embodiments, the registration request may indicate a capability to use relay security with bootstrap keys (RSBK). As shown at 820, the method 800 may include receiving a registration accept from the network. In various embodiments, the registration accept may indicate an authorization for the WTRU to use RSBK. As shown at 830, the method 800 may include generating an anchor key and an anchor key identifier during a primary authentication procedure. As shown at 840, the method 800 may include deriving a remote user key from at least the anchor key based on the authorization to use RSBK, e.g., being received from the network. As shown at 850, the method 800 may include sending a connection request to a relay. In various embodiments, the connection request may comprise at least the anchor key identifier and a first nonce. As shown at 860, the method 800 may include receiving a security establishment request from the relay. In various embodiments, the security establishment request may comprise a second nonce. As shown at 870, the method 800 may include deriving a root key to be shared between the WTRU and the relay based on at least the remote user key, the first nonce and the second nonce.

In various embodiments, the method may further comprise receiving provisioning information from the network, the provisioning information indicating a relay service code associated with an indication to use RSBK.

In various embodiments, the method may further comprise discovering the relay, the relay supporting the relay service code associated with the indication to use RSBK.

In various embodiments, deriving the remote user key may comprise deriving the remote user key further based on the relay service code.

In various embodiments, deriving the root key may comprise deriving the root key further based on the relay service code.

In various embodiments, the method may further comprise deriving any of a session key and security keys based on the root key.

In various embodiments, the method may further comprise verifying the security establishment request based on the security keys.

In various embodiments, the method may further comprise sending a security establishment response to the relay, the security establishment response being protected using the security keys.

In various embodiments, the method may further comprise receiving a connection accept from the relay to complete a connection establishment.

In various embodiments, the anchor key may be an authentication and key management for applications (AKMA) anchor key (KAKMA).

In various embodiments, the remote user key may be a proximity-based service (Prose) remote user key (PRUK).

In various embodiments, the root key to be shared between the WTRU and the relay may be a key new radio Prose (KNRP).

In various embodiments, the connection request may be a direct connection request message.

In various embodiments, the security establishment request may be a direct security mode command message.

In various embodiments, the security establishment response may be a direct security mode complete message.

In various embodiments, the connection accept may be a direct connection accept message.

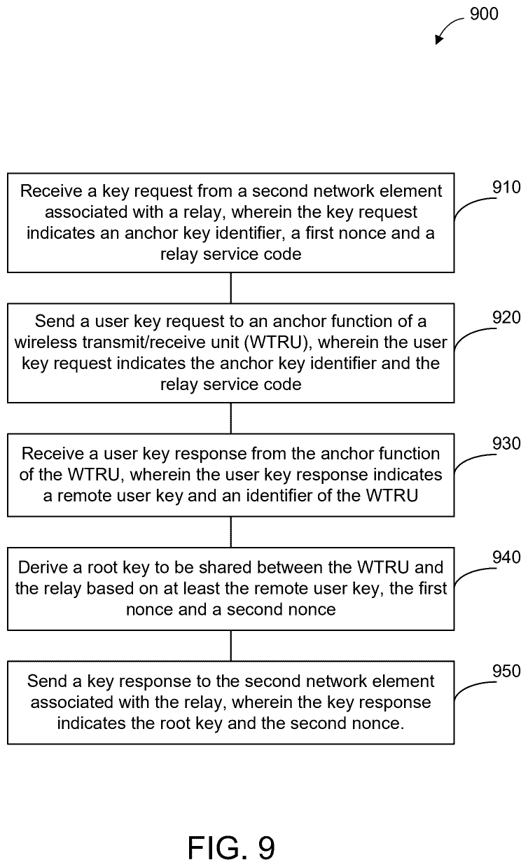

FIG. 9 is a diagram illustrating an example method 900 for relay communication security using bootstrapping, implemented in a first network element. The first network element may include circuitry including any of transmitter, a receiver, a processor, and a memory. The circuitry may be configured to carry out the method 900. The first network element may be associated with a WTRU. As shown at 910, the method 900 may include receiving a key request from a second network element associated with a relay. In various embodiments, the key request may indicate an anchor key identifier, a first nonce and a relay service code. As shown at 920, the method 900 may include sending a user key request to an anchor function of the WTRU. In various embodiments, the user key request may indicate the anchor key identifier and the relay service code. As shown at 930, the method 900 may include receiving a user key response from the anchor function of the WTRU. In various embodiments, the user key response may indicate a remote user key and an identifier of the WTRU. As shown at 940, the method 900 may include deriving a root key to be shared between the WTRU and the relay based on at least the remote user key, the first nonce and a second nonce. As shown at 950, the method 900 may include sending a key response to the second network element associated with the relay. In various embodiments, the key response may indicate the root key and the second nonce.

In various embodiments, deriving the root key may comprise deriving the root key further based on the relay service code.

In various embodiments, the first network element may be a proximity-based service (Prose) anchor function (PAnF) of the WTRU.

In various embodiments, the second network element associated with the relay may be a PAnF of the relay.

In various embodiments, the anchor function of the WTRU may be an authentication and key management for applications (AKMA) anchor function (AAnF) of the WTRU.

The content of each of the following references is incorporated by reference herein in its entirety:
3GPP TS 33.503 “Security Aspects of Proximity based Services (ProSe) in the 5G System (5GS)”, v18.3.0;
3GPP TS 23.304, “Proximity based Services (ProSe) in the 5G System (5GS)”, v19.0.0;
3GPP TS 33.535, “Authentication and Key Management for Applications (AKMA) based on 3GPP credentials in the 5G System (5GS)”, v18.4.0;
3GPP TS 33.501, “Security architecture and procedures for 5G System”, v 18.6.0.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A wireless transmit/receive unit (WTRU) comprising circuitry, including any of a transmitter, a receiver, a processor, and a memory, configured to:
send a registration request to a network, wherein the registration request indicates a capability to use relay security with bootstrap keys (RSBK);
receive a registration accept from the network, wherein the registration accept indicates an authorization for the WTRU to use RSBK;
generate an anchor key and an anchor key identifier during a primary authentication procedure;
derive a remote user key from at least the anchor key based on the authorization to use RSBK;
send a connection request to a relay, wherein the connection request comprises at least the anchor key identifier and a first nonce;
receive a security establishment request from the relay, wherein the security establishment request comprises a second nonce; and
derive a root key to be shared between the WTRU and the relay based on at least the remote user key, the first nonce and the second nonce.

2. The WTRU of claim 1, further configured to receive provisioning information from the network, wherein the provisioning information indicates a relay service code associated with an indication to use RSBK.

3. The WTRU of claim 2, further configured to discover the relay, wherein the relay supports the relay service code associated with the indication to use RSBK.

4. The WTRU of claim 2, wherein the WTRU being configured to derive the remote user key comprises the WTRU being configured to derive the remote user key further based on the relay service code.

5. The WTRU of claim 2, wherein the WTRU being configured to derive the root key comprises the WTRU being configured to derive the root key further based on the relay service code.

6. The WTRU of claim 1, further configured to derive any of a session key and security keys based on the root key.

7. The WTRU of claim 6, further configured to verify the security establishment request based on the security keys.

8. The WTRU of claim 6, further configured to send a security establishment response to the relay, wherein the security establishment response is protected using the security keys.

9. The WTRU of claim 1, further configured to receive a connection accept from the relay to complete a connection establishment.

10. The WTRU of claim 1, wherein the anchor key is an authentication and key management for applications (AKMA) anchor key (KAKMA).

11. The WTRU of claim 1, wherein the remote user key is a proximity-based service (Prose) remote user key (PRUK).

12. The WTRU of claim 1, wherein the root key to be shared between the WTRU and the relay is a key new radio Prose (KNRP).

13. The WTRU of claim 1, wherein the connection request is a direct connection request message.

14. The WTRU of claim 1, wherein the security establishment request is a direct security mode command message.

15. A method implemented in a wireless transmit/receive unit (WTRU), the method comprising:
sending a registration request to a network, wherein the registration request indicates a capability to use relay security with bootstrap keys (RSBK);
receiving a registration accept from the network, wherein the registration accept indicates an authorization for the WTRU to use RSBK;
generating an anchor key and an anchor key identifier during a primary authentication procedure;
deriving a remote user key from at least the anchor key based on the authorization to use RSBK;
sending a connection request to a relay, wherein the connection request comprises at least the anchor key identifier and a first nonce;
receiving a security establishment request from the relay, wherein the security establishment request comprises a second nonce; and
deriving a root key to be shared between the WTRU and the relay based on at least the remote user key, the first nonce and the second nonce.

16. A method implemented in a first network element, the method comprising:
receiving a key request from a second network element associated with a relay, wherein the key request indicates an anchor key identifier, a first nonce and a relay service code;
sending a user key request to an anchor function of a wireless transmit/receive unit (WTRU), wherein the user key request indicates the anchor key identifier and the relay service code;
receiving a user key response from the anchor function of the WTRU, wherein the user key response indicates a remote user key and an identifier of the WTRU;
deriving a root key to be shared between the WTRU and the relay based on at least the remote user key, the first nonce and a second nonce; and
sending a key response to the second network element associated with the relay, wherein the key response indicates the root key and the second nonce.

17. The method of claim 16, wherein deriving the root key comprises deriving the root key further based on the relay service code.

18. The method of claim 16, wherein the first network element is a proximity-based service (Prose) key management function (PKMF) of the WTRU or a Prose anchor function (PAnF) of the WTRU.

19. The method of claim 16, wherein the second network element associated with the relay is a PKMF of the relay or a PAnF of the relay.

20. The method of claim 16, wherein the anchor function of the WTRU is an authentication and key management for applications (AKMA) anchor function (AAnF) of the WTRU.
